(19) United States
(12) Patent Application Publication
(10) Pub. No.: US 2009/0133063 A1
(43) Pub. Date: May 21, 2009

(54) Preference Based Electronic Programming Guide

(75) Inventor: Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/942,856

(22) Filed: Nov. 20, 2007

(51) Int. Cl. G06F 3/00

(52) U.S. Cl. 725/40

(57) ABSTRACT

A set top box is provided that includes a receiver for receiving programming content over a broadband access network and an electronic program guide (EPG) unit for outputting to a display scheduling information associated with programs deliverable over the broadband access network. The EPG is further configured to present on the display a plurality of user-selectable program cells for selecting a program identified by each of the respective cells. The program cells have dimensions that are substantially equal to one another. A processor is operationally associated with the receiver and the EPG unit. A user interface device is provided for selecting among the user-selectable program cells.

### FIELD OF THE INVENTION

The present invention relates generally to electronic programming guides (EPGs) employed by set top terminals, and more particularly to an EPG that displays programming information in a format that allows for customization by the viewer.

### BACKGROUND OF THE INVENTION

A conventional system for displaying a program, e.g., a video program, includes a monitor or a television (TV) set connected to a set top box or terminal. The set top box is connected through a coaxial cable to a cable TV network or a satellite dish for “satellite TV.” The TV set and the set top box are located, for example, in a user's home and receive a multitude of TV channels from a broadcast head end, wherein each TV channel has a multitude of programs during a typical day. In order to select and watch a certain program, the user controls the set top box to tune to a desired channel. The TV set receives a video signal from the set top box and displays the program of the desired channel.

Set top terminals often enhance a television viewer's experience by employing one or more Electronic Program Guides (EPGs). As known in the art, the electronic program guide lists scheduled programs for a predetermined period of time (e.g., two weeks) and provides, among others, information about broadcast dates and times and content information. For example, the program attributes may include the content information, which describes for each program the channel, actor, director, title, genre, language and the like. With an EPG, television viewers navigate through an onscreen program guide to locate programming. Typically viewers browse the guide or query it. With a guide, viewers browse currently available programming and schedules of programming available in the future. By using keywords or categories, viewers typically search the guide for programming. With an EPG, the viewers may also set reminders for upcoming programs or enter instructions to record one or more shows.

FIG. 1 shows an example of a conventional EPG 100 user interface (UI). It typically lists multiple programs (e.g., “Victory” and “Taxi”) in a two-dimensional grid-like pattern. One dimension of the grid is the channel (e.g., “NBC” and “USA”) that is broadcasting the specified programming and the other dimension is its scheduled broadcast times (e.g., “9:00 pm” and “10:00 pm”). As shown in FIG. 1, the length of the program block (e.g., 120) is typically proportional to the length of the program. Also, the program blocks are typically aligned with uniform blocks of times. That way, the front edge of the program blocks for all programs beginning at the same time (e.g., “11:00 pm”) are aligned. Because of this, the user is able to see what programming is available and when it is scheduled to start and end.

The EPG 100 allows a viewer to use a remote control device to scroll as desired, both horizontally across time and vertically through the channel grid. The program blocks are user selectable icons that allow a viewer to tune to the programs listed within the blocks. For example, in FIG. 1 the subscriber has selected the movie “Victory,” as seen by the shading of the grid block. If the subscriber wants to select the television show “Columbo,” all he or she needs to do, for example, is press the right arrow once and the down arrow once and the grid cell 130 for “Columbo” becomes highlighted, as shown in FIG. 2.

Although set-top terminals equipped with an EPG enable users to identify and locate programming of interest to them, it has become more and more difficult and time-consuming to use as the number of channels and diversity of available programming continues to increase. Accordingly, it would be helpful if EPGs could meet these increasing needs in a more intelligent way that quickly and easily conveys information that is desired by the viewer.

### BRIEF DESCRIPTION OF THE DRAWINGS

FIGS. 1 and 2 show an example of a conventional EPG user interface (UI).

FIG. 3 shows a functional block diagram of a digital set-top terminal.

FIG. 4 shows one example of an EPG user interface (UI).

FIGS. 5-7 show other examples of an EPG user interface (UI).

FIG. 8 is a flowchart showing one example of a method by which a user makes a selection using the EPG user interfaces of FIGS. 4-7.

### DETAILED DESCRIPTION

As detailed below, an electronic program guide (EPG) is provided that displays information in an easy to read format that also allows for convenient customization by the viewer based on his or her preferences. For example, the viewer can easily remove from the EPG programs that are of no interest, thus allowing additional programs to be displayed that are of interest.

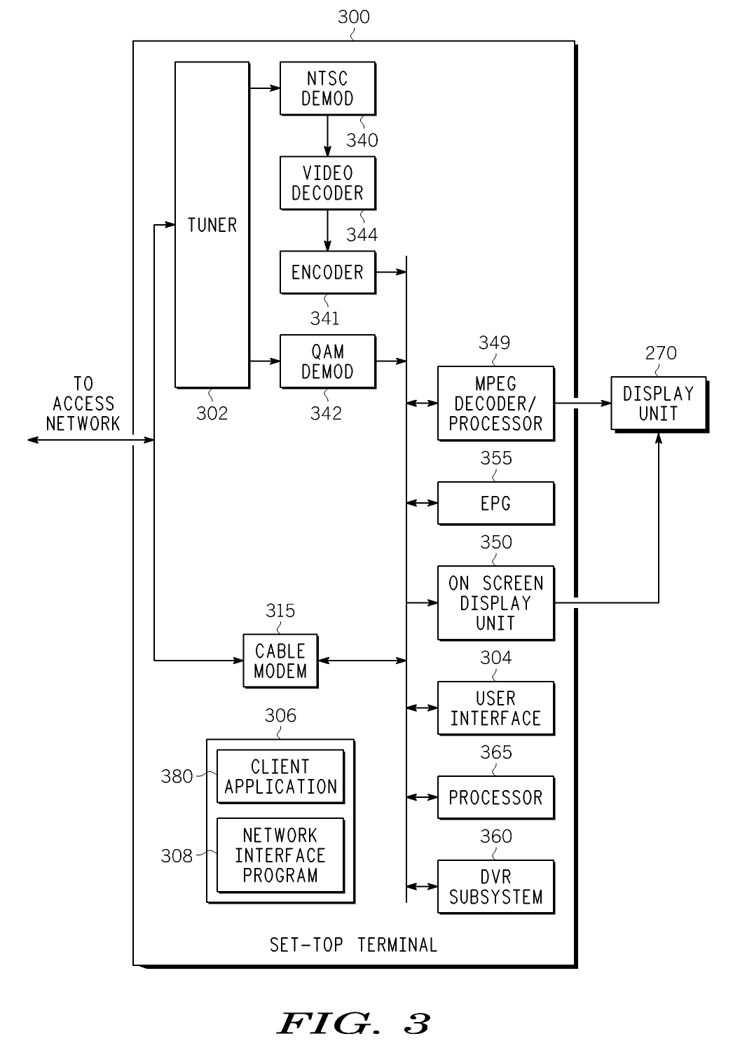

FIG. 3 shows a digital set-top terminal 300. These units offer digital video, audio, and high speed-data services along with streaming media, PPV, Internet services, HDTV, and personal video recorder (PVR) capabilities. The set top terminal 300 can receive programming over a broadband access network such as a cable network, satellite network, packet-switched network and the like. Of course, digital set top terminal 300 is only one example of set top terminal and is presented by way of illustration only.

Set-top terminal 300 includes an in-band tuner 302, which tunes to a channel signal selected by a consumer (not shown) via user interface device 304. User interface device 304 may be any control device such as a remote control, mouse, microphone, keyboard, or display. The controls on the user interface device 304 may include such items as physical buttons, virtual buttons displayed on a touch-sensitive screen, a mouse, trackball, and/or other pointing devices. NTSC demodulator 340 and digital demodulator 342 are responsive to in-band tuner 302. NTSC demodulator 340 includes components responsive to receive analog versions of a channel signal. A digital demodulator 342, which as shown is a QAM demodulator, but, which may be any type of digital demodulator device, includes components responsive to receive digital versions of a channel signal, and to output video information. QAM demodulator 342 receives and processes digital data packets from one or more digital sources, such as a digital television signal, an MPEG transport stream, or a media stream from an external network connection, such as cable modem 315 (if available), using well-known methods and techniques. Video decoder 344 is responsive to receive and decode video information. Video information that may require format translation or modification for compatibility with capabilities of set top terminal 300 may be passed to encoder 341 for formatting. Video information that is in a format preferred for use by MPEG Decoder/Multi Media Processor 349 may be passed directly to MPEG Decoder/Multi Media Processor 349. Encoder 341 is operative to perform predetermined coding techniques (for example, MPEG-2, MPEG-4, and others) to produce an encoded video signal for transmission to MPEG Decoder/Multi Media Processor 349, or for storage. MPEG Decoder/Multi-Media Processor 349 is operative to perform predetermined coding techniques to arrange video information into displayable formats, in accordance with well-known methods and techniques. Internal arrangements of MPEG Decoder/Multi-Media Processor 349 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An electronic program guide (EPG) 355 is also provided in set-top terminal 300. The EPG 355 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 355 may display programs in a tabular format by channel and time so that the user can make selections of desired content. In some cases, instead of transmitting it along with the programming, the electronic program guide 355 may be downloaded via a telephone line, cable connection, satellite up-link, or radio broadcast antenna.

The viewer may browse through the EPG 355, operate features in the EPG 355, refer to data presented on on-screen menus, retrieve selected program guide data, record programs, make selections and configure the program guide. All these operations may be performed either in a conventional mode of operation by pressing keys on a keyboard, remote control or touch screen display associated with user interface 304. Additionally, these operations may be performed while the viewer is viewing programming on display unit 350.

An on-screen display unit 350 is provided in set top terminal 300. The on-screen display unit 350 is used to display information such as control menus and the like as well as information received from the service provider or MSO that needs to be directly presented to the user regardless of the particular programming or channel that the user is currently viewing. In particular, on-screen display unit 350 displays the information provided by the EPG 355. Accordingly, on-screen display unit 350 can forward the information directly to the display unit 270, where it may appear as an overlay, pop up, or scrolling text ticker that is superimposed on the current programming being viewed. Alternatively, the information from the on-screen display unit 350 may even replace the current programming that appears on the display unit 270.

DVR subsystem 360 is provided for recording programs received from the access network. DVR subsystem 360 can control the channel tuned by tuner 302 and record programming on a manual or timer control basis. Additionally, the DVR subsystem 360 can buffer incoming programs to enable a view to pause or replay a portion of a live program.

Set-top terminal 300 further includes a computer-readable storage medium 306. Computer-readable storage medium 306 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 306. The applications residing on storage medium 306 may be computer programs that include software components implemented according to well-known software engineering practices for component-based software development and stored in computer-readable memories, such as storage medium 306. The applications, however, may be any signal processing methods and/or stored instructions, in one or more parts, that electronically control functions set forth herein. Storage medium 306 may also include other programs to provide additional functionality. For example, a network interface program 308 may be provided that represents aspects of the functional arrangement of various computer programs that pertain to the receipt and processing of content and other data over the broadband system 100.

The various components of set top terminal 300 discussed above may all operate under the overall control of a processor 365. Moreover, it is contemplated that the processor 365, tuner 302, video decoder 349, user interface 304, onscreen display unit 350 and the other components shown in FIG. 3 may each be implemented in hardware, software or a combination thereof. In addition, although the various components are shown as separate processors, it is contemplated that they may be combined and implemented as separate processes on one or more processors.

Current digital broadcasting systems may include two hundred or more channels that are available to viewers. In this regard, it is impractical to scan all the available channels to search for a desired broadcast program. The EPG 355 helps viewers to more quickly and efficiently search for a desired program. However, with so many available channels, even searching through the entire EPG can be arduous. As previously mentioned, it would be helpful if the EPG were formatted so that it could be readily tailored to individual preferences of each viewer. This can be accomplished with any of the various EPG user interface presented below.

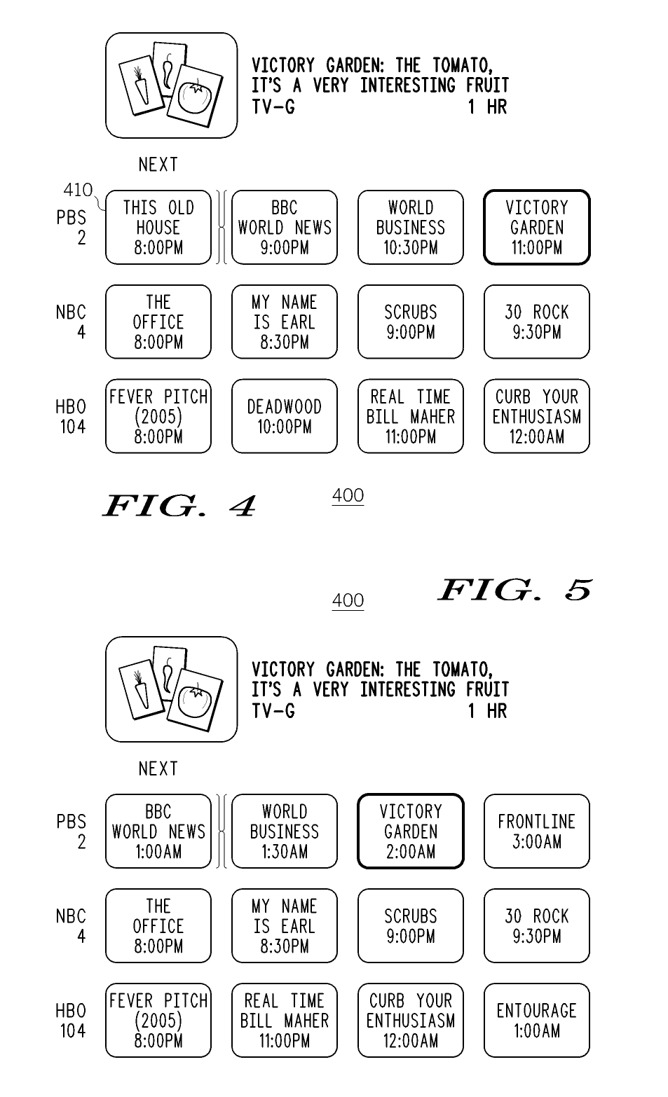

FIG. 4 shows one example of an EPG user interface (UI) 400. The EPG 400 is formatted as a series of rows, each of which denote a different channel (e.g., “PBS 2,” “NBC 4” and “HBO 104”) or, in some cases, a content provider (e.g., “Disney”). Each row includes a series of program cells (e.g., 410) that identifies a program being broadcast on that channel and the time at which it begins. For purposes of illustration only the cells are shown in the shape of the blocks and will hereinafter be referred to as either program cells or blocks. The program blocks may include other information pertaining to the scheduled programs such as whether the program is a first-airing or a previously-aired program, the program genre, actors or the like. As shown in FIG. 4, the program blocks are uniform in length along the rows. That is, the length of the blocks of each program block (e.g., 410) are the same regardless of the length of the program. While the program blocks shown in FIG. 4 are presented in sequential order beginning with programming that is currently being delivered, the blocks may be presented within their respective rows in any appropriate sequence, which in some cases may be a user-selectable parameter. Also, while each channel is represented along a different row, other arrangements are also contemplated. For example, in some cases each channel may be represented along a different column.

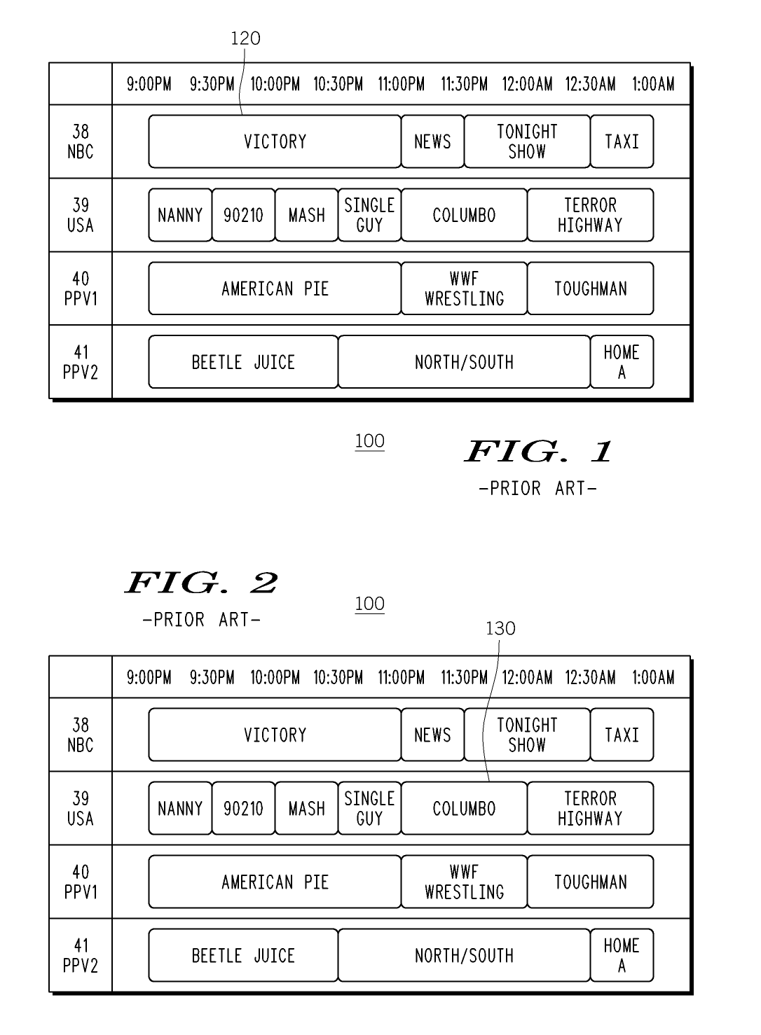

The EPG 400 allows a viewer to use the user interface device to scroll as desired, both horizontally across time and vertically through the channel grid. The program blocks are user selectable program icons that upon selection allow a viewer to tune to the programs listed within the blocks. For example, in FIG. 1 the subscriber has selected the program “Victory Garden” on PBS, as seen by the bold outline of the grid block. If the subscriber wants to select a different program, all he or she needs to do is select the appropriate program icon.

In some cases, when a viewer selects a particular cell or scrolls to a particular row of cells, the cell or cells may increase in size or appear magnified. This can be accomplished through the use of animation or scalable vector graphics. The content of the cell may scale with the increased size of the cell or change to provide additional details that were not available before the cell increased in size.

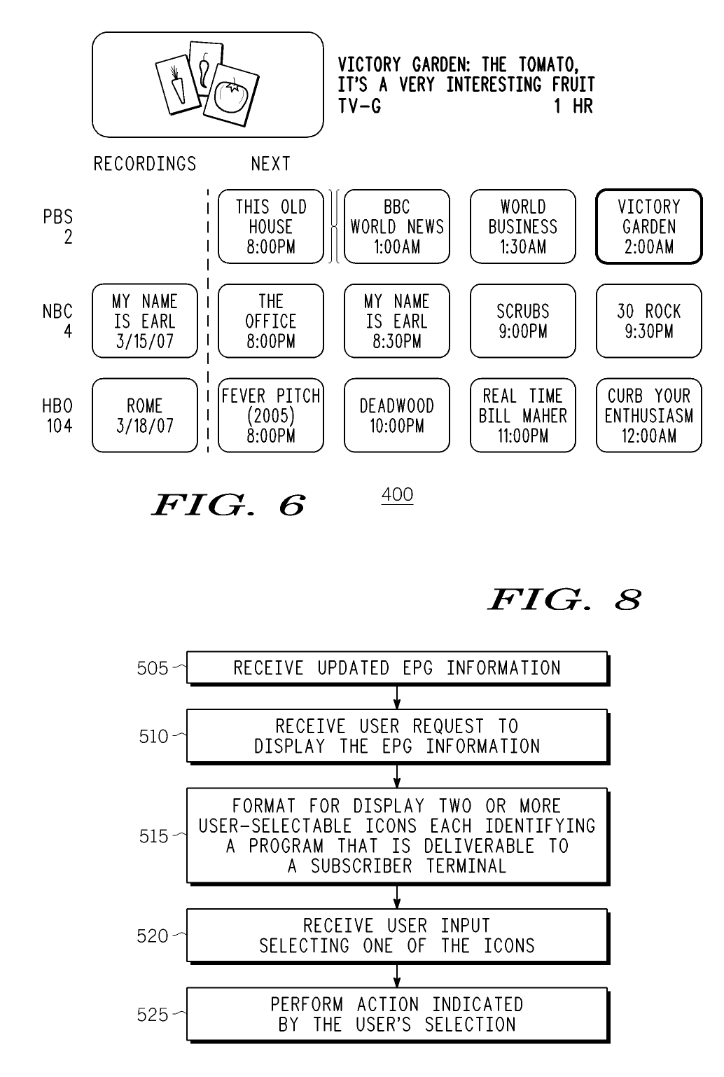

One advantage of the EPG user interface 400 depicted in FIG. 4 is that in some cases the viewer may be provided with the capability to both simplify and customize the EPG 400 in a convenient manner. For example, in some cases the viewer can delete program cells or blocks that represent programs of no interest to the viewer so that these program blocks do not distract the viewer. Deleting program blocks also provides room for additional program blocks to be seen on the EPG which are of interest to the viewer. Program blocks may be deleted in any suitable manner using the user interface device. For example, after selecting a program block to be deleted, the user can depress a delete button to remove the selected program from the EPG. As another example, selection of a program block may activate a pull-down menu that is displayed in or over the EPG. The menu can include various options such as “delete all episodes,” “delete this episode only,” “delete repeats only,” “go to channel,” etc. FIG. 5 shows an example of the EPG user interface 400 after the viewer has removed two programs (“This Old House” and “Deadwood”).

FIG. 6 shows another example of the EPG user interface 400 that includes any programs that have been recorded on the DVR subsystem 360. This provides the viewer with a convenient, integrated visual display of all programs that are available for viewing, regardless of whether they are stored locally or distributed over a cable, satellite or other network. As shown, in this example the recorded programs are presented in program blocks that are the same as the program blocks in which the scheduled broadcast programs are presented, although this need not be the case. For instance, in some cases the program blocks for recorded programs may be visually distinct from the program blocks for the scheduled broadcast programming so that the viewer can easily distinguish among them. Also in this particular example the program blocks for the recorded programs are presented in the row associated with the channel from which the program was recorded. In addition, these program blocks precede the scheduled programming. Of course, in other cases these program blocks may be presented at the end of the scheduled programming or even interspersed among the scheduled programming. The program blocks for the recorded program include the title of the programs and the date of recording.

FIG. 7 shows yet another example of the EPG user interface 400 in which additional user-selectable control icons or cells 430, 440 and 450 are provided. When the “now playing” control icon or cell 430 is selected the EPG user interface displays a list of a shows currently being delivered or deliverable over the broadband access network. When the “three at a glance” control icon or cell 440 is selected a specified number (e.g., 6) of upcoming programs are displayed for three channels at a time. Similarly, when the “one at a glance” control icon or cell 450 is selected a specified number (e.g., 18) of upcoming programs are displayed for just one channel at a time.

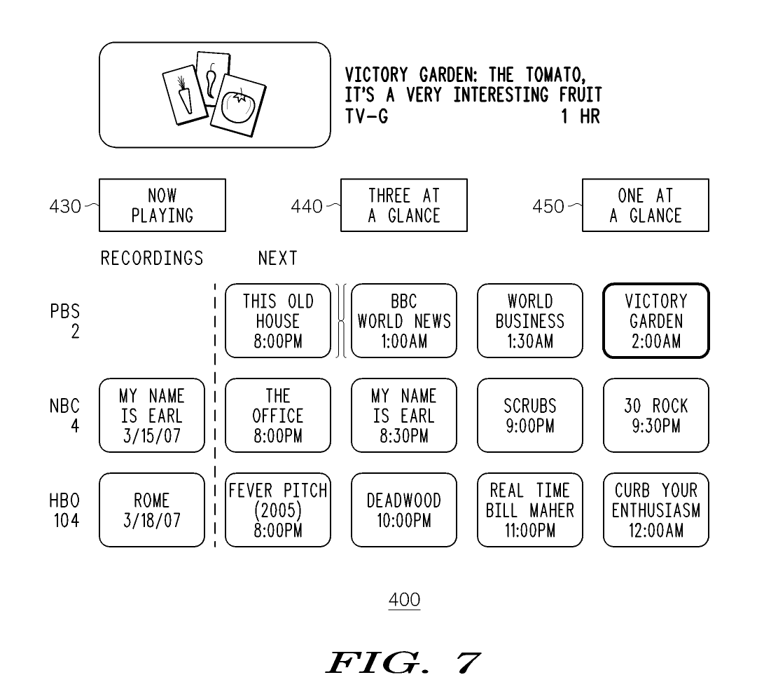

FIG. 8 is a flowchart showing one example of a method by which a user makes a selection using the EPG user interfaces presented above. The method begins in step 505 when the EPG unit 355 in the set top terminal 300 receives updated EPG information pertaining to the programs that are deliverable over the access network or stored on a local or network DVR. Next, in step 510 the set top terminal 300 receives a user request to display the EPG information. In response to the request, in step 515 the EPG unit 355 formats for display on a television or the like two or more user-selectable icons each identifying a program that is deliverable to a subscriber terminal. The icons have dimensions that are independent of program length. In step 520 the user selects one of the icons. The set top terminal 300 responds to the user's selection in step 525 by taking the appropriate action reflected by the selection of the icon. For example, the set top terminal 300 may tune to the channel on which the program identified by the selected icon is being presented.

The processes described above in connection with the set-top terminal 300 may be implemented in general, multi-purpose or single purpose processors respectively associated with the set-top terminal 300. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A computer-readable storage medium containing instructions which, when performed by one or more processors disposed in an electronic device, implement a user interface performing a method comprising:
receiving electronic program guide (EPG) data; and
formatting the EPG data into at least a first icon and a second icon, wherein each icon represents a program that is deliverable to a subscriber terminal, wherein the icons have dimensions that are independent of program length;
responding to a user's selection of at least one of the icons.

2. The computer-readable storage medium of claim 1 wherein the formatting is performed so that the icons are enclosed regions that each occupy a substantially equal area and in which a title is presented of the program respectively associated therewith, said icons being arranged in a grid pattern.

3. The computer-readable storage medium of claim 2 wherein the formatting is performed so that each row or column of the grid pattern represents a different channel on which the programs are made available.

4. The computer-readable storage medium of claim 2 wherein the formatting is performed so that each row or column of the grid pattern represents a different content provider from which programs are made available.

5. The computer-readable storage medium of claim 2 wherein icons in at least one of the rows or columns are larger than icons in remaining ones of the rows or columns.

6. The computer-readable storage medium of claim 2 wherein icons in a selected one of the rows or columns are larger than icons in remaining ones of the rows or columns.

7. The computer-readable storage medium of claim 1 further comprising, in response to receipt of a user input, removing a selected program from the EPG.

8. The computer-readable storage medium of claim 7 wherein all future presentations of the selected program are removed from the EPG unless and until a user input is received indicating otherwise.

9. The computer-readable storage medium of claim 1 further comprising, in response to receipt of a user input reflecting a selection of particular icon, formatting for display a pull-down menu of options relating to the program identified by the particular icon.

10. The computer-readable storage medium of claim 1 further comprising formatting user-selectable icons identifying programs deliverable to the subscriber terminal over an access network and recorded programs locally available on a DVR associated with the subscriber terminal.

11. The computer-readable storage medium of claim 3 further comprising formatting user-selectable icons identifying programs deliverable to the subscriber terminal over an access network and recorded programs locally available on a DVR associated with the subscriber terminal.

12. The computer-readable storage medium of claim 11 wherein the icons identifying recorded programs are located in the row or column that represents the channel from which the programs were recorded.

13. The computer-readable storage medium of claim 1 wherein user selection of a first control icon causes a reconfiguration in display of program icons.

14. The computer-readable storage medium of claim 13 wherein selection of a second control icon causes display of program icons identifying a predetermined number of programs associated with a predetermined number of channels.

15. The computer-readable storage medium of claim 1 wherein a user selection deleting the first icon causes the second icon to occupy a position formerly occupied by the first icon.

16. A set top box comprising:
a receiver for receiving programming content over a broadband access network;
an EPG unit for outputting to a display scheduling information associated with programs deliverable over the broadband access network, wherein the EPG is further configured to present on the display a plurality of user-selectable program cells for selecting a program identified by each of the respective cells, the program cells having dimensions that are substantially equal to one another;
a processor operationally associated with the receiver and the EPG unit; and
a user interface device for selecting among the user-selectable program cells.

17. The set top terminal of claim 16 wherein each of the program cells is individually selectively removable by a subscriber via the user interface.

18. The set top terminal of claim 16 wherein the program cells are arranged in a grid pattern, and wherein each row or column of the grid pattern represents a different channel on which the programs are made available.

19. The set top terminal of claim 16 wherein each of the cells is independently selectively removable from the display via the user interface.

20. The set top terminal of claim 16 further comprising a digital storage medium for storing programming content received over the broadband access network, wherein the plurality of user-selectable cells include user-selectable cells icons identifying programs stored on the digital storage medium.

21. The set top terminal of claim 16 wherein the EPG unit is further configured such that in response to receipt of a user input reflecting a selection of particular cell, displaying a pull-down menu of options relating to the program identified by the particular cell.

22. The set top terminal of claim 17 wherein the cells identifying programs stored on the digital storage medium are located in a row or column that represents a channel from which the programs were recorded.

23. The set top terminal of claim 16 wherein the EPG unit is further configured such that an arrangement of the cells as presented on the display is user-configurable.

24. The set top terminal of claim 23 wherein a first of the cells is user-selectable to configure the arrangement of the cells as presented on the display.
